(19) United States
(12) Patent Application Publication
(10) Pub. No.: US 2017/0171367 A1
(43) Pub. Date: Jun. 15, 2017

(54) Method for resisting an interference of high-order harmonics on MIPI bus of camera and mobile terminal

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Siyang LIU, Beijing (CN); Donghai LIU, Beijing (CN)

(21) Appl. No.: 15/244,773

(22) Filed: Aug. 23, 2016

Related U.S. Application Data
(63) Continuation of application No. PCT/CN2016/088663, filed on Jul. 5, 2016.

(30) Foreign Application Priority Data
Dec. 11, 2015 (CN) 2015109208974

(51) Int. Cl. H04M 1/02; G06F 13/42

(52) U.S. Cl. CPC H04M 1/0202; G06F 13/4282

(57) ABSTRACT

Disclosed are a method and an apparatus for resisting an interference of high-order harmonics on a MIPI bus of a camera and a mobile terminal, a correspondence between a radio frequency communication frequency band available for a mobile terminal and a safety frequency of the MIPI bus of the camera is stored in the mobile terminal in advance, high-order harmonics generated when the MIPI bus of the camera operates in the safety frequency do not fall within a range of the radio frequency communication frequency band corresponding to the safety frequency, the method includes: detecting a radio frequency communication frequency band currently used by the mobile terminal; querying the safety frequency corresponding to the radio frequency communication frequency band currently used by the mobile terminal based on the correspondence; and setting the current operating frequency as the queried safety frequency of the MIPI bus of the camera.

### CROSS REFERENCE TO RELATED APPLICATIONS

The present application is a continuation of PCT application which has an application number of PCT/CN2016/088663 and was filed on Jul. 5, 2016. This application claims the priority to Chinese Patent Application No. 201510920897.4, entitled “METHOD AND APPARATUS FOR RESISTING AN INTERFERENCE OF HIGH-ORDER HARMONICS ON MIPI BUS OF CAMERA AND MOBILE TERMINAL” and filed with the Chinese State Intellectual Property Office on Dec. 11, 2015, which is incorporated herein by reference in its entirety.

### TECHNICAL FIELD

The disclosure relates to the field of mobile application processor, and particularly to a method for resisting an interference of high-order harmonics and a mobile terminal.

### BACKGROUND

A display having a high resolution and a camera having a high pixel have become a necessity with the development of the mobile terminal technology.

A greater volume of data is generated with the raise of a pixel of the camera, and further an operating frequency of a MIPI (Mobile Industry Processor Interface) bus for transmitting data is required to be greater and greater. High-order harmonics are generated inevitably during the operation of the MIPI bus, and some of the high-order harmonics will fall within a range of radio frequency communication frequency band, and therefore is received by an antenna of the mobile terminal, which will result in reducing receiving sensitivity of the antenna and even affecting a normal call of the mobile terminal in a severe case.

An existing solution is to add a high-frequency filtering circuit (common mode choke in general) in circuit design, to filter the high-order harmonics via the high-frequency filtering circuit. However, it can be found by the inventor of the present disclosure that, the greater the attenuation of the high-frequency filtering circuit, the better the effect of filtering the high-order harmonics, the greater the influence on a waveform of an MIPI signal, which results in that the quality of the MIPI is unqualified, and the less the attenuation of the high-frequency filtering circuit, the smaller the influence on the waveform of the MIPI signal, and the poorer the effect of filtering the high-order harmonics.

### SUMMARY

In view of this, a method for resisting an interference of high-order harmonics on a MIPI bus of a camera and a mobile terminal, to ensure that the quality of an MIPI signal is not affected on the premise of resisting an interference of the high-order harmonics on the MIPI bus.

A method for resisting an interference of high-order harmonics on a MIPI bus of a camera is provided according to a first aspect of the present disclosure. Specifically, a correspondence between a radio frequency communication frequency band available for a mobile terminal and a safety frequency of the MIPI bus of the camera is stored in the mobile terminal in advance. High-order harmonics generated when the MIPI bus of the camera operates in the safety frequency do not fall within a range of the radio frequency communication frequency band corresponding to the safety frequency. The method may include: detecting a radio frequency communication frequency band currently used by the mobile terminal; querying a safety frequency of the MIPI bus of the camera corresponding to the radio frequency communication frequency band currently used by the mobile terminal based on the correspondence; and setting a current operating frequency of the MIPI bus of the camera as the queried safety frequency of the MIPI bus of the camera.

A mobile terminal is provided according to a second aspect of the present disclosure. The mobile terminal comprises:

at least one processor; and

a memory storing one or more programs and a correspondence between a radio frequency communication frequency band available for the mobile terminal and a safety frequency of a MIPI bus of a camera, wherein high-order harmonics generated when the MIPI bus of the camera operates in the safety frequency do not fall within a range of the radio frequency communication frequency band corresponding to the safety frequency;

wherein execution of the one or more programs by the at least one processor causes the at least one processor to:

detect the radio frequency communication frequency band currently used by the mobile terminal;

query the safety frequency of the MIPI bus of the camera corresponding to the radio frequency communication frequency band currently used by the mobile terminal based on the correspondence; and

set a current operating frequency of the MIPI bus of the camera as a queried safety frequency of the MIPI bus of the camera.

In the method for resisting an interference of the high-order harmonics according to the embodiment of the present disclosure, the correspondence between a radio frequency communication frequency band available for a mobile terminal and a safety frequency of an MIPI bus of a camera is stored in the mobile terminal, the high-order harmonics generated when the MIPI bus of the camera operates in the safety frequency do not fall within a range of the radio frequency communication frequency band corresponding to the safety frequency. The method may include: detecting a radio frequency communication frequency band currently used by the mobile terminal; querying a safety frequency of the MIPI bus of the camera corresponding to the radio frequency communication frequency band currently used by the mobile terminal based on the correspondence; and setting a current operating frequency of the MIPI bus of the camera as queried safety frequency of the MIPI bus of the camera. Furthermore, an operating frequency of the MIPI bus of the camera is set with respect to any radio frequency communication frequency band available for the mobile terminal, to acquire a safety frequency of the radio frequency communication frequency band. In a case that the mobile terminal is applied, the operating frequency of the MIPI bus of the camera is set as the queried safety frequency, thereby avoiding occurring a harmonic interference of the frequency of the camera from the source.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram of an MIPI interface used by a mobile terminal in the conventional technology;

FIG. 2 is a flow diagram of a method for resisting an interference of high-order harmonics on an MIPI bus of a camera according to an embodiment of the present disclosure;

FIG. 3 is a flow diagram of a method for determining a correspondence between a radio frequency communication frequency band available for the mobile terminal and a safety frequency of an MIPI bus of a camera according to an embodiment of the present disclosure;

FIG. 4 is a schematic connection diagram between the apparatus for resisting an interference of high-order harmonics on an MIPI of a camera and a camera driver chip according to an embodiment of the present disclosure;

FIG. 5 is a structural diagram of an apparatus for resisting an interference of high-order harmonics according to an embodiment of the present disclosure;

FIG. 6 is a schematic block diagram of a computing device for implementing the method for resisting an interference of high-order harmonics on an MIPI bus of a camera according to an embodiment of the present disclosure; and

FIG. 7 is a schematic diagram of a storage unit for storing and carrying program codes for implementing the method for resisting an interference of high-order harmonics on an MIPI bus of a camera according to an embodiment of the present disclosure.

### DETAILED DESCRIPTION

The exemplary embodiments of the present disclosure are described in detail below with reference to the drawings. Although the exemplary embodiments of the present disclosure are displayed in the drawings, it should be understood that the present disclosure can be realized in various ways, and is not limited to be realized by the embodiments described here. In contrary, the exemplary embodiments are provided to fully understand the present disclosure and completely convey the scope of the present disclosure to those skilled in the art.

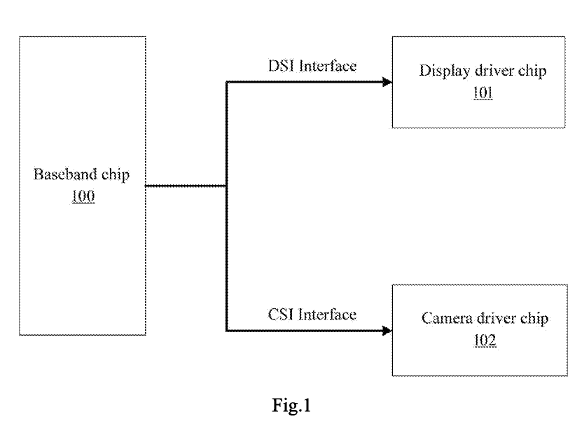

FIG. 1 is a schematic structural diagram of an MIPI interface used by a mobile terminal in the conventional technology. A baseband chip 100, a display driver chip 101 and a camera driver chip 102 of a mobile terminal are shown in FIG. 1. In a case that the mobile terminal is started, the baseband chip 100 reads configuration for each chip from a static storage region, and the camera driver chip 101 and the camera driver chip 102 are started respectively based on the configuration for the chip.

Specifically, the baseband chip 100 communicates with the camera driver chip 101 via a DSI (Camera Serial Interface) in the MIPI protocol, and the baseband chip 100 communicates with the camera driver chip 102 via a CSI (Camera Serial Interface). A high-speed serial interface between a processor and a camera module is defined by the DSI, and a high-speed serial interface between the processor and a camera module is defined by the CSI.

The communication between the baseband chip 100 and the camera driver chip 101 may interfere with a communication frequency band of a radio frequency network currently used by the mobile terminal. A part of communication frequency bands of the radio frequency network used by the mobile terminal are listed in Table 1-1.

TABLE 1-1

| | Band | | | | | | | | | | |
|---|---|---|---|---|---|---|---|---|---|---|---|
| | GSM | GSM | DCS | PCS | | WALN | | | | | |
| | 850 | 900 | 1800 | 1900 | GPS | 2.4 | Band1 | Band2 | Band3 | Band4 | Band5 |
| Frequency | 889-894 | 925-960 | 1805-1880 | 1930-1990 | 1575.42 | 2400-2500 | 2110-2170 | 1930-1990 | 1805-1880 | 2110-2115 | 869-894 |
| band (MHz) | | | | | | | | | | | |

In a case that high-order harmonics generated due to the operating frequency of the MIPI bus of the camera fall within the frequency band described above when the mobile terminal performs communication, the high-order harmonics may be received by an antenna, which results in bad communication of the mobile terminal.

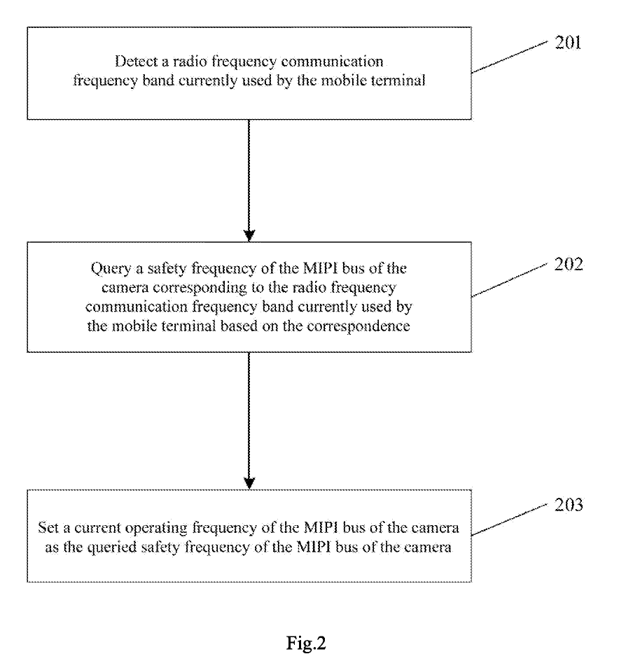

Therefore, as shown in FIG. 2, a method for resisting an interference of high-order harmonics on an MIPI bus of a camera is provided according to an embodiment of the present disclosure based on the conventional technology, the method includes steps 201 to 203.

In step 201, a radio frequency communication frequency band currently used by a mobile terminal is detected. A two-dimensional relation table between a network type and a communication frequency band is stored in storage of a mobile terminal, as shown in Table 1-1. In a preferable embodiment, a communication frequency band of the mobile terminal can be acquired based on a radio frequency network type used by the mobile terminal. For example, in a case that the mobile terminal performs communication in a frequency band in GSM900, a receiving frequency of the mobile terminal ranges from 925 MHz to 959.8 MHz.

In step 202, a safety frequency of the MIPI bus of the camera corresponding to the radio frequency communication frequency band currently used by the mobile terminal is inquired based on a correspondence. A correspondence between a radio frequency communication frequency band available for a mobile terminal and a safety frequency of the MIPI bus of the camera is stored in the storage of the mobile terminal in advance. Specifically, high-order harmonics generated when the MIPI bus of the camera operates in the safety frequency do not fall within a range of the radio frequency communication frequency band corresponding to the safety frequency. In this step, a current safety frequency of the mobile terminal is acquired based on the radio frequency communication frequency band currently used by the mobile terminal acquired in step 202.

In step 203, a current operating frequency of the MIPI bus of the camera is set as the inquired safety frequency of the MIPI bus of the camera.

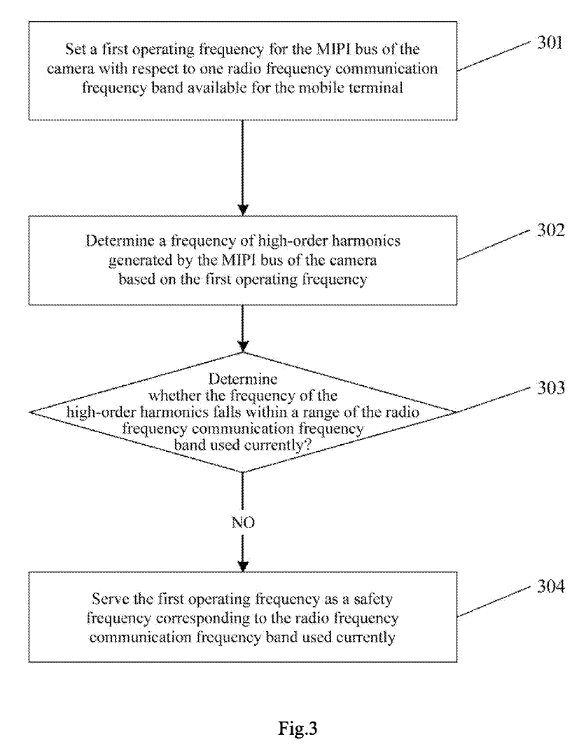

In an optional embodiment, as shown in FIG. 3, determining the network radio frequency communication frequency band and the safety frequency of the MIPI bus of the camera includes step 301 to step 304.

In step 301, a first operating frequency is set for the MIPI bus of the camera with respect to a radio frequency communication frequency band available for the mobile terminal. For example, in a case that the radio frequency communication frequency band currently used by the mobile terminal ranges from 925 MHz to 959.8 MHz, the first operating frequency set for the MIPI bus of the camera of the mobile terminal is 800 MHz, which is set by an engineer based on design experience.

In step 302, a frequency of high-order harmonics generated by the MIPI bus of the camera is determined based on the first operating frequency. A frequency of a received high-order harmonics generated by the MIPI bus of the camera is measured by a measurement device for the high-order harmonics.

In an optional embodiment, a ¼ frequency division frequency or a 1/12 frequency division frequency of the operating frequency of the MIPI bus of the camera is calculated, and a frequency multiplexing frequency of the frequency division frequency is then calculated as the frequency of the high-order harmonics generated by the MIPI bus of the camera.

One clock channel Lane (channel) and one to four data Lanes (channel) are defined by the DSI interface between the baseband chip and the camera driver chip to transmit data. Whether the ¼ frequency division frequency or the 1/12 frequency division frequency is used to calculate the frequency multiplexing frequency is determined based on the number of channels (Lane) in the MIPI bus of the camera. RGB (Red, Green and Blue) signals in the MIPI bus are transmitted in parallel. In a case that the number of lanes in the MIPI bus is two, a same color component (R, G or B) is repeated every three clock periods. In a case that the number of lanes in the MIPI bus is three, a same color component (R, G or B) is repeated every clock period. In a case that the number of lanes in the MIPI bus is four, a same color component (R, G or B) is repeated every three clock periods, and so forth. Two color components data can be transmitted within each clock period, each color component data includes eight bytes. Therefore, in a case that the color component data is repeated every three clock periods, MIPI interference interval=MIPI frequency*2/(8*3)=MIPI frequency/12; in a case that the color component data is repeated every clock period, MIPI interference interval=MIPI frequency*2/(8*1)=MIPI frequency/4. In a case that the number of lanes in the MIPI bus is two, the MIPI interference interval is the 1/12 frequency division frequency of a MIPI frequency. In a case that the number of lanes in the MIPI bus is three, the MIPI interference interval is the ¼ frequency division frequency of the MIPI frequency. In a case that the number of MIPI channels is four, the MIPI interference interval is the 1/12 frequency division frequency of the MIPI frequency, and so forth.

In step 303, it is determined whether the frequency of the high-order harmonics falls within the radio frequency communication frequency band currently used. Step 304 is executed in a case that the frequency of the high-order harmonics does not fall within the radio frequency communication frequency band currently used.

In step 304, the first operating frequency is served as a safety frequency corresponding to the radio frequency communication frequency band currently used.

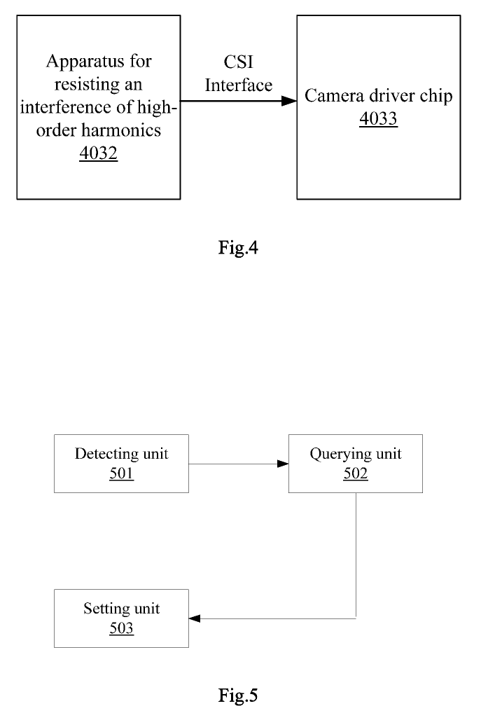

Corresponding to the flow diagram of the method for resisting an interference of high-order harmonics on a MIPI bus of a camera shown in FIG. 2, an apparatus for resisting an interference of high-order harmonics on a MIPI bus of a camera is provided according to an embodiment of the present disclosure, as shown in FIG. 4 and FIG. 5.

FIG. 4 is a schematic connection diagram between the apparatus for resisting an interference of high-order harmonics on a MIPI bus of a camera according to an embodiment of the present disclosure and the camera driver chip. In FIG. 4, an apparatus 4032 for resisting an interference of the high-order harmonics acquires a correspondence between a radio frequency communication frequency band and a safety frequency of a MIPI bus of a camera, and acquires a safety frequency of the MIPI bus of the camera of the mobile terminal based on the correspondence, and a current operating frequency of the MIPI bus of the camera is set as the safety frequency by a camera driver chip 4033.

FIG. 5 is a structural diagram of an apparatus for resisting an interference of high-order harmonics on a MIPI bus of a camera according to an embodiment of the present disclosure. The apparatus described above includes a detecting unit 501, a querying unit 502 and a setting unit 503.

The detecting unit 501 is configured to detect a radio frequency communication frequency band currently used by a mobile terminal.

The querying unit 502, connected with the detecting unit 501, is configured to query a safety frequency of the MIPI bus of the camera corresponding to the radio frequency communication frequency band currently used by the mobile terminal based on a correspondence between a radio frequency communication frequency band available for the mobile terminal and a safety frequency of a MIPI bus of a camera. Specifically, high-order harmonics generated when the MIPI bus of the camera operates in the safety frequency do not fall within a range of the radio frequency communication frequency band corresponding to the safety frequency.

The setting unit 503 is configured to set a current operating frequency of the MIPI bus of the camera to the safety frequency of the MIPI bus queried by the querying unit 502.

Optionally, the detecting unit 501 includes: a recognizing module configured to recognize a current network type of the mobile terminal; and a determining module configured to determine the radio frequency communication frequency band based on the network type. The network type described above includes GSM850, GSM900, WI-FI2.4G GPS, 3G and 4G.

Based on the method for resisting an interference of the high-order harmonics according to the embodiment of the present disclosure, a mobile terminal is provided to implement the method described above, and the mobile terminal includes a storage and a processor.

The storage is configured to store a correspondence between a radio frequency communication frequency band available for a mobile terminal and a safety frequency of an MIPI bus of a camera. High-order harmonics generated when the MIPI bus of the camera operates in the safety frequency do not fall within a range of the radio frequency communication frequency band corresponding to the safety frequency.

The processor is configured to: detect a radio frequency communication frequency band currently used by the mobile terminal; query a safety frequency of the MIPI bus of the camera corresponding to the radio frequency communication frequency band currently used by the mobile terminal based on the correspondence stored in the storage; and adjust a current operating frequency of the MIPI bus of the camera to be the queried safety frequency of the MIPI bus of the camera.

In the method for resisting an interference of the high-order harmonics according to the embodiment of the present disclosure, the correspondence between a radio frequency communication frequency band available for a mobile terminal and a safety frequency of an MIPI bus of a camera is stored in the mobile terminal, the high-order harmonics generated when the MIPI bus of the camera operates in the safety frequency do not fall within a range of the radio frequency communication frequency band corresponding to the safety frequency. The method may include: detecting a radio frequency communication frequency band currently used by the mobile terminal; querying a safety frequency of the MIPI bus of the camera corresponding to the radio frequency communication frequency band currently used by the mobile terminal based on the correspondence; and setting a current operating frequency of the MIPI bus of the camera as queried safety frequency of the MIPI bus of the camera. Furthermore, a safety frequency of the MIPI bus of the camera is set with respect to any radio frequency communication frequency band available for the mobile terminal. In a case that the mobile terminal is applied, the operating frequency of the MIPI bus of the camera is set as the queried safety frequency, thereby avoiding occurring a harmonic interference of the frequency of the camera from the source.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not sown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawings, or description thereof in the above description of the exemplary embodiments of the disclosure. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or processes or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the description (including the attached claims, abstract and figures) can be replaced by substitute feature providing the same, equivalent or similar purpose.

In addition, a personal skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components according to the embodiments in the disclosure in practice. The disclosure can also realize one part of or all devices or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

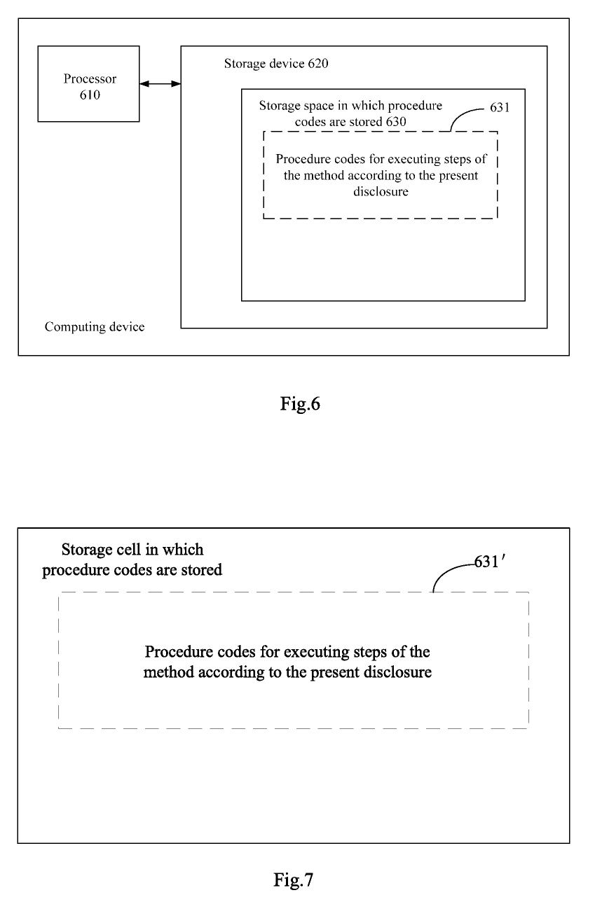

For example, FIG. 6 shows a computing device for achieving the parking method according to the disclosure. The computing device traditionally includes a processor 610 and a computer program product or a computer readable medium embodying as a storage 620. The storage 620 can be electronic storage such as flash memory, EEPROM (Electrically Erasable Programmable Read-Only Memory), EPROM, hard disk or ROM, and the like. The storage 620 possesses storage space 630 for carrying out procedure code 631 of any steps of aforesaid method. For example, storage space 630 for procedure code can comprise various procedure codes 631 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as said in FIG. 7. The storage cell can possess memory paragraph, storage space like the storage 620 in the computing device in FIG. 6. The procedure code can be compressed in, for example, a proper form. Generally, storage cell comprises computer readable code 631′ for performing method steps of the disclosure, i.e. the code can be read by processors such as 610 and the like. When the codes run on a computer device, the computer device will carry out various steps of the method described above.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the devices can be embodied by a same hardware item. The use of words first, second and third does not mean any sequence. These words can be explained as name.

1. A method for resisting an interference of high-order harmonics on a MIPI bus of a camera, wherein a correspondence between a radio frequency communication frequency band available for a mobile terminal and a safety frequency of the MIPI bus of the camera is stored in the mobile terminal in advance, high-order harmonics generated when the MIPI bus of the camera operates in the safety frequency do not fall within a range of the radio frequency communication frequency band corresponding to the safety frequency, the method comprises:
detecting the radio frequency communication frequency band currently used by the mobile terminal;
querying the safety frequency of the MIPI bus of the camera corresponding to the radio frequency communication frequency band currently used by the mobile terminal based on the correspondence; and
setting a current operating frequency of the MIPI bus of the camera as a queried safety frequency of the MIPI bus of the camera.

2. The method according to claim 1, wherein determining the correspondence between a radio frequency communication frequency band available for the mobile terminal and a safety frequency of the MIPI bus of the camera comprises:
setting a first operating frequency for the MIPI bus of the camera with respect to any one radio frequency communication frequency band available for the mobile terminal;
determining a frequency of high-order harmonics generated by the MIPI bus of the camera based on the first operating frequency; and
serving the first operating frequency as a safety frequency corresponding to the any one radio frequency communication frequency band in a case that the frequency of the high-order harmonics does not fall within a range of the any one radio frequency communication frequency band.

3. The method according to claim 2, wherein one or at least two safety frequencies are determined with respect to one radio frequency communication frequency band.

4. The method according to claim 2, wherein the determining the frequency of the high-order harmonics generated by the MIPI bus of the camera based on the first operating frequency comprises:
calculating a ¼ frequency division frequency or a 1/12 frequency division frequency of the operating frequency of the MIPI bus of the camera; and
calculating a frequency multiplication frequency of the frequency division frequency and serving the frequency multiplication frequency as the frequency of the high-order harmonics generated by the MIPI bus of the camera.

5. The method according to claim 1, wherein the detecting the radio frequency communication frequency band currently used by the mobile terminal comprises:
recognizing a current network type of the mobile terminal; and
determining the radio frequency communication frequency band currently used by the mobile terminal based on the network type.

6. The method according to claim 5, wherein the network type comprises at least one of GSM850, GSM900, WI-FI 2.4G, GPS, 3G and 4G.

7. A mobile terminal, comprising:
at least one processor; and
a memory storing one or more programs and a correspondence between a radio frequency communication frequency band available for the mobile terminal and a safety frequency of a MIPI bus of a camera, wherein high-order harmonics generated when the MIPI bus of the camera operates in the safety frequency do not fall within a range of the radio frequency communication frequency band corresponding to the safety frequency;
wherein execution of the one or more programs by the at least one processor causes the at least one processor to:
detect the radio frequency communication frequency band currently used by the mobile terminal;
query the safety frequency of the MIPI bus of the camera corresponding to the radio frequency communication frequency band currently used by the mobile terminal based on the correspondence; and
set a current operating frequency of the MIPI bus of the camera as a queried safety frequency of the MIPI bus of the camera.

8. The mobile terminal according to claim 7, wherein
the execution causes the at least one processor further to:
recognize a current network type of the mobile terminal; and
determining the radio frequency communication frequency band currently used by the mobile terminal based on the network type.

9. The mobile terminal according to claim 8, wherein the network type comprises at least one of GSM850, GSM900, WI-FI 2.4G, GPS, 3G and 4G.

10. (canceled)
